(19) United States
(12) Patent Application Publication
(10) Pub. No.: US 2018/0365478 A1
(43) Pub. Date: Dec. 20, 2018

(54) MULTI-MODAL TYPE WEARABLE USER AUTHENTICATION APPARATUS USING BIO SIGNAL

(71) Applicant: Korea Internet & Security Agency, Seoul (KR)

(72) Inventors: Saewoom LEE, Seoul (KR); Jason KIM, Seoul (KR)

(73) Assignee: Korea Internet & Security Agency, Seoul (KR)

(21) Appl. No.: 15/816,257

(22) Filed: Nov. 17, 2017

(30) Foreign Application Priority Data
Jun. 19, 2017 (KR) 10-2017-0077415

(51) Int. Cl. G06K 9/00; G06F 21/32

(52) U.S. Cl. CPC G06K 9/00087; G06K 2009/00939; G06K 9/00912; G06F 21/32

(57) ABSTRACT

A multi-modal type wearable user authentication apparatus includes a housing; an electrode plate disposed at a rear surface of the housing to contact a user wrist; a display panel disposed at a front surface of the housing; and a multi-modal type user authentication sensor including mutually separated first and second electrodes disposed at the lower end of the display panel and constituting an edge and a bio recognition module disposed at the center.

### BACKGROUND OF THE INVENTION

### Technical Field

The present invention relates to user authentication technology using a bio signal, and more particularly, to a multi-modal type wearable user authentication apparatus that can perform user authentication by simultaneous receiving a bio signal and a fingerprint when a finger pressure is detected.

### Description of Related Art

User authentication technology based on bio recognition may determine similarity through comparison of sensor data acquired based on a biometric sensor or a bio signal sensor with original data at a database to authenticate a user with a method of determining whether the same person.

In such conventional technology, because there is the difference in a result according to a state of a measuring person or a measurement environment, there is a drawback that reliability is somewhat is deteriorated and that security stability is weak in a counterfeit fingerprint attack such as paper and silicon.

Korean Patent Laid-Open Publication No. 10-2017-0034618 relates to a user authentication method using bio information, an authentication server for user authentication, and a bio recognition apparatus, and the user authentication method includes steps of collecting a user's first bio information, transmitting the first bio information to an authentication server, collecting the user's second bio information, and transmitting the second bio information to the authentication server when user authentication about first bio information is succeeded.

Korean Patent Publication No. 10-1646566 relates to a user authentication method and system through electrocardiogram signal recognition in a bio signal measurement environment using a wearable sensor, and the user authentication method includes steps of (1) collecting, by an authentication data collection unit, user authentication data, (2) transmitting the authentication data collected at step 1 to an authentication unit through wired and wireless communication, and (3) comparing the authentication data transmitted to the authentication unit at step 2 with previously stored user data to authenticate a user.

### PRIOR ART DOCUMENT

### Patent Document

Korean Patent Laid-Open Publication No. 10-2017-0034618 (Mar. 29, 2017)

Korean Patent Publication No. 10-1646566 (Aug. 2, 2016)

### SUMMARY OF THE INVENTION

The present invention has been made in view of the above problems and provides a multi-modal type wearable user authentication apparatus that can perform user authentication by simultaneous receiving a bio signal and a fingerprint of a user when a finger pressure is detected.

The present invention further provides a multi-modal type wearable user authentication apparatus formed in a half-ring shape and that can improve measurement of a user bio signal through first and second electrodes separated from each other.

The present invention further provides a multi-modal type wearable user authentication apparatus that can perform user authentication in which security is reinforced through analysis of a correlation between a bio signal and a fingerprint.

In accordance with an aspect of the present invention, a multi-modal type wearable user authentication apparatus includes a housing; an electrode plate disposed at a rear surface of the housing to contact a user wrist; a display panel disposed at a front surface of the housing; and a multi-modal type user authentication sensor including mutually separated first and second electrodes disposed at the lower end of the display panel and constituting an edge and a bio recognition module disposed at the center.

The first electrode may be disposed in a direction of the display panel and have an upper portion coated with an insulating material in order to prevent interference from occurring due to a finger contact.

The first electrode may correspond to a reference electrode using when sensing a bio signal formed through the electrode plate and the second electrode.

The multi-modal type wearable user authentication apparatus may further include a switch disposed at the lower end of the first electrode to detect a finger pressure.

The multi-modal type wearable user authentication apparatus may further include a control module included within the housing and that receives a fingerprint acquired through the bio recognition module and a bio signal acquired through the electrode plate and the first and second electrodes, when the finger pressure is detected.

The control module may analyze a correlation between the received fingerprint and the received bio signal to perform user authentication.

The control module may determine effectiveness by analyzing whether the received bio signal exists within an effective segment.

The control module may extract a first characteristic point related to a dynamic element from the received bio signal and extract a second characteristic point related to a static element from the acquired fingerprint, if the effectiveness is effective.

In accordance with another aspect of the present invention, a multi-modal type wearable user authentication method is performed by a multi-modal type wearable user authentication apparatus. The multi-modal type wearable user authentication method includes steps of acquiring a fingerprint through a bio recognition module; acquiring a bio signal through an electrode plate and first and second electrodes; detecting a finger pressure through a switch; receiving, when the finger pressure is detected, the acquired fingerprint and the acquired bio signal; and performing user authentication by analyzing a correlation between the received fingerprint and the received bio signal.

In accordance with another aspect of the present invention, a computer readable recording medium that can be executed by a computer that records a computer program of a multi-modal type wearable user authentication method includes a function of acquiring a fingerprint through a bio recognition module; a function of acquiring a bio signal through an electrode plate and first and second electrodes; a function of detecting a finger pressure through a switch; a function of receiving the acquired fingerprint and the acquired bio signal, when the finger pressure is detected; and a function of performing user authentication by analyzing a correlation between the received fingerprint and the received bio signal.

### Advantages

Disclosed technology can have the following effects. However, it does not mean that a specific exemplary embodiment should include the entire following effects or should include only the following effects, and thus it should not be understood that the scope of disclosed technology is limited thereto.

A multi-modal type wearable user authentication apparatus according to an exemplary embodiment of the present invention can simultaneously receive a user's bio signal and a fingerprint to perform user authentication, when a finger pressure is detected.

A multi-modal type wearable user authentication apparatus according to an exemplary embodiment of the present invention can be formed in a half-ring shape and improve bio signal measurement of a user through first and second electrodes separated from each other.

A multi-modal type wearable user authentication apparatus according to an exemplary embodiment of the present invention can perform user authentication in which security is reinforced through correlation analysis between a bio signal and a fingerprint.

### BRIEF DESCRIPTION OF THE DRAWINGS

FIG. 1 is a diagram illustrating a multi-modal type wearable user authentication apparatus according to an exemplary embodiment of the present invention.

FIG. 2A is a side view illustrating the multi-modal type wearable user authentication apparatus of FIG. 1.

FIG. 2B is a diagram illustrating constituent elements of a multi-modal type user authentication sensor of FIG. 2A.

FIG. 3 is a diagram illustrating a disposition of a switch that detects a finger pressure.

FIG. 4 is a flowchart illustrating a multi-modal type user authentication procedure performed by a multi-modal type wearable user authentication apparatus.

### DETAILED DESCRIPTION OF THE INVENTION

An exemplary embodiment of the present invention is merely an exemplary embodiment for a structural or functional description of the present invention and thus it should not be analyzed that the scope of the present invention is limited by an exemplary embodiment described in a detailed description. That is, because an exemplary embodiment may be variously changed and have several forms, it should be understood that the scope of the present invention include equivalents that can realize the spirit thereof. Further, it does not mean that a specific exemplary embodiment should include entire objects or effects suggested in the present invention or should include only such effects and thus it should not be understood that the scope of the present invention is limited thereto.

A meaning of terms described in an exemplary embodiment of the present invention should be understood as follows.

A term such as “first” and “second” is used for distinguishing a constituent element from another constituent element and the scope of the present invention is not limited by the terms. For example, a first constituent element may be referred to as a second constituent element and similarly, a second constituent element may be referred to as a first constituent element.

When it is described that a constituent element is “connected” or “electrically connected” to another constituent element, the element may be “directly connected” or “directly electrically connected” to the other constituent elements or may be “connected” or “electrically connected” to the other constituent elements through a third element. However, when it is described that a constituent element is “directly connected” or “directly electrically connected” to another constituent element, no element may exist between the element and the other element. Other expressions, i.e., “between” and “immediately between” or “adjacent to” and “directly adjacent to” describing a relationship between constituent elements should be similarly analyzed.

Singular forms used here include a plurality of forms unless phrases explicitly represent an opposite meaning, and a term of “comprising” or “having” used in a specification embodies a characteristic, number, step, operation, element, component, or combination thereof and does not exclude presence or addition of at least one characteristic, number, step, operation, element, component, or combination thereof.

In each step, identification symbols (e.g., a, b, and c) are used for convenience of description and do not describe order of each step, and unless each step does not clearly describe specific order in a context, the each step may occur differently from listed order. That is, each step may occur in the same order as listed order, may be substantially simultaneously performed, and may be performed in opposite order.

The present invention may be implemented with a computer readable code in a computer readable recording medium, and the computer readable recording medium includes all kinds of record devices that store data that can be read by a computer system. The computer readable recording medium may include, for example, a read-only memory (ROM), a random-access memory (RAM), a compact disc-ROM (CD-ROM), a magnetic tape, a floppy disk, and an optical data storage.

Unless differently defined, all terms used here have the same meaning as a meaning that may be generally understood by a person of common skill in the art. It should be analyzed that terms defined in a generally using dictionary have a meaning corresponding with that of a context of related technology and are not analyzed as an ideal or excessively formal meaning unless explicitly defined in the present invention.

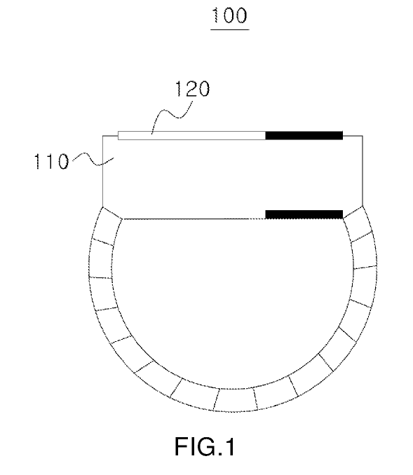

FIG. 1 is a diagram illustrating a multi-modal type wearable user authentication apparatus according to an exemplary embodiment of the present invention.

Referring to FIG. 1, a multi-modal type wearable user authentication apparatus 100 includes a housing 110 and a display panel 120.

The multi-modal type wearable user authentication apparatus 100 using a bio signal corresponds to a computing device that can perform user authentication based on multi-modal. In an exemplary embodiment, the multi-modal type wearable user authentication apparatus 100 may be implemented into a wearable device such as an accessory type or a body attachment type.

The housing 110 may include a first housing and a second housing, and here, the first housing and the second housing are coupled to each other.

The housing 110 may be formed in a circular shape. In an exemplary embodiment, a shape of the housing 110 is not limited to a circle and may be variously changed. More specifically, the housing 110 may mount the display panel 120, an electrode plate 210, a multi-modal type user authentication sensor 220, a switch 230, and a control module 240 to be described later.

The display panel 120 may be disposed at a front surface of the housing 110.

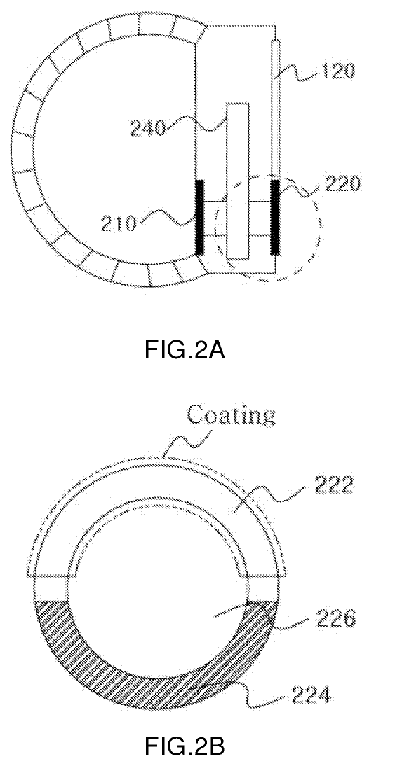

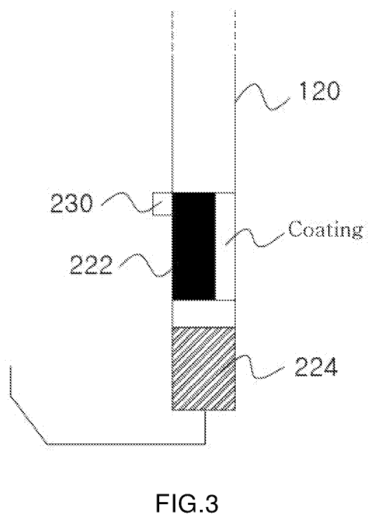

Hereinafter, a detailed description on the multi-modal type wearable user authentication apparatus 100 will be described with reference to FIGS. 2 and 3.

FIG. 2A is a side view illustrating the multi-modal type wearable user authentication apparatus of FIG. 1, FIG. 2B is a diagram illustrating constituent elements of a multi-modal type user authentication sensor of FIG. 2A, and FIG. 3 is a diagram illustrating a disposition of a switch that detects a finger pressure.

Referring to FIGS. 2A, 2B, and 3, the multi-modal type wearable user authentication apparatus 100 may include an electrode plate 210, a multi-modal type user authentication sensor 220, a switch 230, and a control module 240. More specifically, the multi-modal type user authentication sensor 220 may include a first electrode 222, a second electrode 224, and a bio recognition module 226. In an exemplary embodiment, the first and second electrodes 222 and 224 may be formed in a half-ring shape, and a shape of the first and second electrodes 222 and 224 may not be limited to a half-ring shape and may be variously changed. For example, the first and second electrodes 222 and 224 may be formed in a half-quadrangle (e.g., a shape in which an intermediate portion of a quadrangle is separated by a specific gap).

The multi-modal type user authentication sensor 220 may be disposed at the lower end of the display panel 120 in the multi-modal type wearable user authentication apparatus 100. The first electrode 222 and the second electrode 224 may be separated from each other by a specific gap to configure an edge of the multi-modal type user authentication sensor 220, and the bio recognition module 226 may be disposed at the center of the multi-modal type user authentication sensor 220.

The electrode plate 210 may correspond to a positive electrode for sensing a bio signal corresponding to a user's bio signal information. More specifically, the electrode plate 210 may be disposed at a rear surface of the housing 110 to contact a user's wrist.

The first electrode 222 may be disposed in a direction of the display panel 120 and have an upper portion coated with an insulating material in order to prevent interference from occurring due to a finger contact.

The second electrode 224 may correspond to a negative electrode for sensing a bio signal corresponding to a user's bio signal information. More specifically, the second electrode 224 may be disposed at a front surface of the housing 110 to contact a user finger of the side that does not wear the multi-modal type wearable user authentication apparatus 100.

The bio recognition module 226 may be implemented with a bio-metric sensor that can acquire a fingerprint corresponding to user bio recognition information, and here, a user fingerprint may correspond to user intrinsic identification information.

The switch 230 may be disposed at the lower end of the first electrode 222 and detect a finger pressure.

The multi-modal type wearable user authentication apparatus 100 may acquire user bio signal information and user bio recognition information. Here, bio signal information is information about a user electric, optical, or chemical bio signal and may include at least one of electrocardiogram (ECG) related to a heart rate and a heartbeat of a heart, electroencephalogram (EEG) related to an active state of cerebrum, electromyogram (EMG) related to an active state of a muscle, ballistocardiogram (BCG) related to a movement of a heartbeat, and photoplethysmogram (PPG) related to a vascular volume change in a body end portion.

When a user wrist contacts the electrode plate 210 and a user finger contacts the second electrode 224, the multi-modal type wearable user authentication apparatus 100 may acquire a formed user bio signal. For example, when sensing a bio signal formed through the electrode plate 210 and the second electrode 224, the multi-modal type wearable user authentication apparatus 100 may use the first electrode 222 as a reference electrode. Further, when a user finger contacts the bio recognition module 226, the multi-modal type wearable user authentication apparatus 100 may acquire a user fingerprint.

When a finger pressure is detected through the switch 230 disposed at the lower end of the first electrode 222, the multi-modal type wearable user authentication apparatus 100 may simultaneously acquire a user fingerprint and bio signal. In an exemplary embodiment, the multi-modal type wearable user authentication apparatus 100 may acquire a user fingerprint through the bio recognition module 226 and acquire a user bio signal through the electrode plate 210, the first electrode 222, and the second electrode 224.

The control module 240 may be included within the housing 110 and receive a user's fingerprint and bio signal. More specifically, when a finger pressure is detected through the switch 230, the control module 240 may receive a fingerprint acquired through the bio recognition module 226 and a bio signal acquired through the electrode plate 210 and the first and second electrodes 222 and 224. Therefore, the control module 240 may perform user authentication based on the received fingerprint and bio signal.

The control module 240 may analyze whether a received bio signal exists within an effective segment to determine effectiveness. In an exemplary embodiment, the control module 240 may store information about a value range, an area range, and a pattern range designated as a determination reference range of effectiveness of each of ECG, EEG, EMG, BCG, and PPG as an effective segment. Here, the effective segment may include a value range, an area range, or a pattern range of a bio signal in a general state excluding an excessive excited state or a severe tension state according to drinking or exercise. For example, when it is analyzed that user bio signal information measured during exercise or immediately after exercise is deviated from an effective segment, the control module 240 may determine that corresponding bio signal information is not effective and not perform user authentication of a corresponding user.

The control module 240 may analyze a user state and dynamically adjust at least one the upper limit and the lower limit for defining an effective segment according to an analyzed user state. In an exemplary embodiment, the control module 240 may compare and analyze a measured user bio signal based on an already stored reference value, reference area, and reference pattern, determine a corresponding user state to one of a static state, a general state, and a dynamic state, and perform dynamic adjustment that reduces, maintains or increases at least the upper limit and the lower limit of at least one of a value range, an area range, and a pattern range at an effective segment according to each state relative to a reference value.

The control module 240 may analyze a correlation between a received fingerprint and a received bio signal to perform user authentication. In an exemplary embodiment, the control module 240 may analyze a correlation between a received bio signal and a received fingerprint with a method of analyzing a correlation (1) representing between variables of a bio signal and a fingerprint or (2) representing between absolute amounts of a bio signal and a fingerprint. The control module 240 may manage simultaneously acquired bio signal information (ECG, PPG) and bio recognition information (fingerprint) in a bio information pair.

If effectiveness is effective, the control module 240 may extract a first characteristic point related to a dynamic element from a received bio signal and extract a second characteristic point related to a static element from an acquired fingerprint. Here, a dynamic element is represented in a bio signal and may correspond to a dynamic parameter of a bio signal characteristic in which data measured from a corresponding user according to a time or a situation may be generally changed, and a static element is represented in a fingerprint and may correspond to a static parameter of a bio recognition characteristic in which data measured from a corresponding user according to a time or a situation is not generally changed.

In an exemplary embodiment, the control module 240 may perform a weight value calculation of first and second characteristic points in order of a fingerprint and a bio signal in a first and second characteristic point extraction process. For example, when it is determined to effective, in a process of extracting a first characteristic point from a bio signal, the control module 240 may reflect a first weight value to a bio signal to extract a first characteristic point, and here, the weight value may be adjusted by a user or a designer.

In an exemplary embodiment, the control module 240 may analyze a correlation between a fingerprint and a bio signal based on at least one of a correlation table of a positive and a negative, a strength and weakness level, and a frequency distribution of a correlation representing between variables of extracted first and second characteristic points. More specifically, the control module 240 may simultaneously acquire a pair of a bio signal and a fingerprint of a user (current user authentication target) through the bio recognition module 226, the electrode plate 210, the first electrode 222, and the second electrode 224, acquire at least twice times such bio information (bio signal information and bio recognition information) pair at a specific time interval to collect a plurality of bio information pairs, and compare an analyzed correlation of a plurality of first and second characteristic point pairs extracted from the plurality of collected bio information pairs and a correlation stored to be related to a user (user previously registered for user authentication) stored at a memory module to determine similarity therebetween. For example, when a value of a first characteristic point extracted from a bio signal increases, if a value of a second characteristic point extracted from a fingerprint strongly increases, the control module 240 may determine that the characteristic points have a strong positive correlation and compare and analyze whether the correlation is similar to a stored correlation to determine whether user authentication is normal authentication or failure authentication.

In another exemplary embodiment, the control module 240 may compare and analyze a calculated vector calculation result of the extracted first and second characteristic points through a vector calculation and a vector calculation reference result stored at the memory module to analyze a correlation. More specifically, the control module 240 may represent a vector calculation result of first and second characteristic points in a vector graph to represent the vector calculation result at a specific location on a multidimensional coordinate plane, represent a plurality of vector calculation reference results corresponding to each of extracted first and second characteristic points among vector calculate information related to a user stored at the memory module on a corresponding coordinate plane, and analyze whether a corresponding vector calculation result approaches within a specific distance from a plurality of vector calculation reference results to exist within a specific correlation range and to determine whether user authentication is normal authentication or failure authentication.

The control module 240 may separately perform user first authentication and second authentication. Here, the first authentication is authentication on whether a user bio signal corresponds and may correspond to primarily performed user authentication, and the second authentication is authentication on whether a user fingerprint corresponds and may correspond to secondarily performed user authentication following the first authentication.

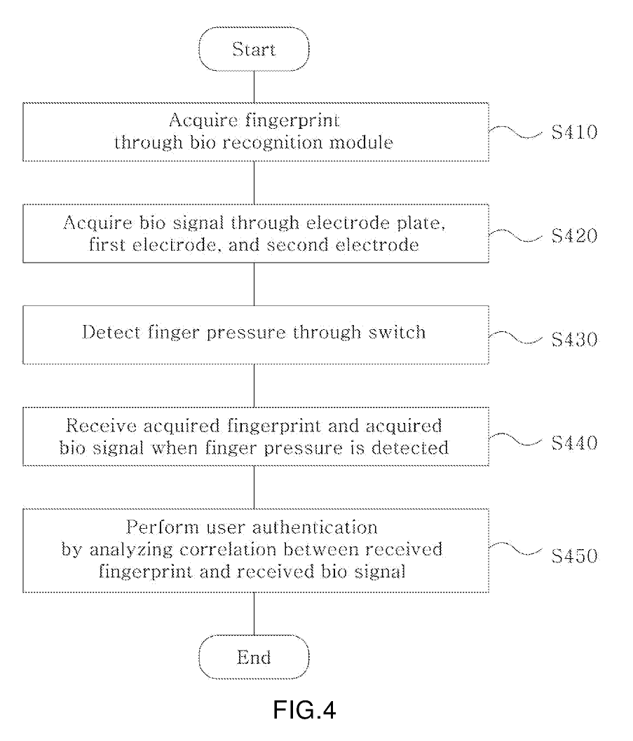

FIG. 4 is a flowchart illustrating a multi-modal type user authentication procedure performed by a multi-modal type wearable user authentication apparatus.

Referring to FIG. 4, when a user finger contacts the bio recognition module 226, the multi-modal type wearable user authentication apparatus 100 may acquire a fingerprint (step S410), and when a user wrist (i.e., a user wrist of the side that does not contact the bio recognition module 226) contacts the electrode plate 210, the multi-modal type wearable user authentication apparatus 100 may acquire a bio signal through the electrode plate 210, the first electrode 222, and the second electrode 224 (step S420).

The multi-modal type wearable user authentication apparatus 100 may detect a finger pressure through a switch disposed at the lower end of the first electrode 222 (step S430), and when a finger pressure is detected, the multi-modal type wearable user authentication apparatus 100 may simultaneously receive the acquired bio signal and the acquired fingerprint (step S440).

The multi-modal type wearable user authentication apparatus 100 may analyze a correlation between the received fingerprint and the received bio signal and perform user authentication of a corresponding user based on the analyzed correlation (step S450).

Although exemplary embodiments of the present disclosure have been described in detail hereinabove, it should be clearly understood that many variations and modifications of the basic inventive concepts herein described, which may appear to those skilled in the art, will still fall within the spirit and scope of the exemplary embodiments of the present disclosure as defined in the appended claims.

What is claimed is:

1. A multi-modal type wearable user authentication apparatus, comprising:
a housing;
an electrode plate disposed at a rear surface of the housing to contact a user wrist;
a display panel disposed at a front surface of the housing; and
a multi-modal type user authentication sensor comprising mutually separated first and second electrodes disposed at the lower end of the display panel and constituting an edge and a bio recognition module disposed at the center.

2. The multi-modal type wearable user authentication apparatus of claim 1, wherein the first electrode is disposed in a direction of the display panel and has an upper portion coated with an insulating material in order to prevent interference from occurring due to a finger contact.

3. The multi-modal type wearable user authentication apparatus of claim 2, wherein the first electrode corresponds to a reference electrode using when sensing a bio signal formed through the electrode plate and the second electrode.

4. The multi-modal type wearable user authentication apparatus of claim 1, further comprising a switch disposed at the lower end of the first electrode to detect a finger pressure.

5. The multi-modal type wearable user authentication apparatus of claim 4, further comprising a control module included within the housing and that receives a fingerprint acquired through the bio recognition module and a bio signal acquired through the electrode plate and the first and second electrodes, when the finger pressure is detected.

6. The multi-modal type wearable user authentication apparatus of claim 5, wherein the control module analyzes a correlation between the received fingerprint and the received bio signal to perform user authentication.

7. The multi-modal type wearable user authentication apparatus of claim 6, wherein the control module determines effectiveness by analyzing whether the received bio signal exists within an effective segment.

8. The multi-modal type wearable user authentication apparatus of claim 7, wherein the control module extracts a first characteristic point related to a dynamic element from the received bio signal and extracts a second characteristic point related to a static element from the acquired fingerprint, if the effectiveness is effective.

9. A multi-modal type wearable user authentication method performed by a multi-modal type wearable user authentication apparatus, the multi-modal type wearable user authentication method comprising:
acquiring a fingerprint through a bio recognition module;
acquiring a bio signal through an electrode plate and first and second electrodes;
detecting a finger pressure through a switch;
receiving, when the finger pressure is detected, the acquired fingerprint and the acquired bio signal; and
performing user authentication by analyzing a correlation between the received fingerprint and the received bio signal.

10. A computer readable recording medium that can be executed by a computer that records a computer program of a multi-modal type wearable user authentication method comprising:
a function of acquiring a fingerprint through a bio recognition module;
a function of acquiring a bio signal through an electrode plate and first and second electrodes;
a function of detecting a finger pressure through a switch;
a function of receiving the acquired fingerprint and the acquired bio signal, when the finger pressure is detected; and
a function of performing user authentication by analyzing a correlation between the received fingerprint and the received bio signal.
